(19) United States
(12) Patent Application Publication
(10) Pub. No.: US 2003/0146938 A1
(43) Pub. Date: Aug. 7, 2003

(54) Fast scrolling through image sets containing markers

(76) Inventor: Bernhard Geiger, Cranbury, NJ (US)

Correspondence Address: Siemens Corporation, Intellectual Property Department, 186 Wood Avenue South, Iselin, NJ, 08830, US

(21) Appl. No.: 10/323,404

(22) Filed: Dec. 19, 2002

Related U.S. Application Data
(60) Provisional application No. 60/342,942, filed on Dec. 20, 2001.

(51) Int. Cl. G09G 5/00

(52) U.S. Cl. 345/784

(57) ABSTRACT

A system for reviewing a plurality of images, at least one image including a marker, is provided. The system includes a display for displaying the plurality of images sequentially; a cursor control device for controlling a speed of the sequentially displayed images, the cursor control device including a feedback mechanism; and a processor for receiving a direction control signal from the cursor control device and presenting the sequence of images to the display in the determined direction, and for determining if any image in the sequence has a marker, wherein if a marker is detected, the processor outputs a feedback signal to the feedback mechanism of the cursor control device to indicate to a user to review the image. Similarly, a method for reviewing a plurality of images at high speed is also provided.

### PRIORITY

This application claims priority to an application entitled “FAST SCROLLING THROUGH IMAGE SETS CONTAINING MARKERS” filed in the United States Patent and Trademark Office on Dec. 20, 2001 and assigned Ser. No. 60/342,942, the contents of which are hereby incorporated by reference.

### BACKGROUND OF THE INVENTION

1. Field of the Invention

The present invention relates generally to computer vision and imaging systems, and more particularly, to a system and method for reviewing a large volume of images at a high speed where the images, including at least one object of interest, are marked and when marked images are encountered feedback is provided to a user to review the image.

2. Description of the Related Art

Medical image data, such as computerized tomography (CT) or magnetic resonance (MR) data, consists of a series of two-dimensional (2D) cross-sectional images of the human body. In many applications, a radiologist has to scroll through a large volume of these images to find a pathology or landmark, e.g., an object of interest. In a situation where an object of interest is detected, the radiologists will mark the object and/or image containing the object so he will be able to easily find it at a later date, or so another radiologist can find it. By marking the object, the user places a visual indication on the image, e.g., text, a small arrow, highlighted area, etc. Alternatively, an automatic image detection system or algorithm can find features and objects of interest and mark the features and/or images containing such features. For example, in the case of lung nodule detection, a typical dataset would contain 300-400 images of an individual's chest. The radiologist would scroll through the images and mark all modules found. Independently, a computer-assisted detection system could mark potential nodules as well.

However, due to the large volume of images to be reviewed, a user interface (UI) for scrolling through the images needs to be intuitive, easy to use and allow a very fine control of the scrolling speed. Furthermore, the images containing a marker should be detected easily, even if scrolling is done at a high speed.

The easiest solution for finding marked images of a large set of images would be a NEXT button, on a touch screen display or on a keyboard of a personal computer (pc), that would display the next image containing a marker. However, the user would be tempted to just look at the marked images, instead of carefully verifying the complete set of images for omitted features. Additionally, putting visual markers on the image itself is a problem because the markers may interfere with the image and a single marker could be easily missed when scrolling through at fast speed.

### SUMMARY OF THE INVENTION

A system and method for reviewing a large volume of images at high speed is provided. A cursor control device, e.g., a joystick, with force feedback is employed to scroll through a series of images on a display where feedback is provided to a user when a marked image is encountered. The joystick can control the direction in which to scroll the images as well as the speed of scrolling. The markers can be felt as small zones of attraction. If the user wants to look at any marked image, the user would scroll through the set of images at moderate speed, until they feel feedback to stop, e.g., a small bump. The user then can either let the joystick loose, in which case they would be attracted to the image containing the maker, or they can overcome the attraction by using more force, to continue scrolling. The marking can be accomplished by tagging images containing objects of interest, even without visual markers that would interfere with the images.

According to one aspect of the present invention, a system for reviewing a plurality of images, at least one image including a marker is provided. The system includes a display for displaying the plurality of images sequentially; a cursor control device for controlling a speed of the sequentially displayed images, the cursor control device including a feedback mechanism; and a processor for receiving a direction control signal from the cursor control device and presenting the sequence of images to the display in the determined direction, and for determining if any image in the sequence has a marker, wherein if a marker is detected, the processor outputs a feedback signal to the feedback mechanism of the cursor control device to indicate to a user to review the image. The system further includes a storage device for storing the plurality of images.

In another aspect of the present invention, the cursor control device is a joystick. The cursor control device includes a movable member manipulated by the user in at least one degree of freedom; and a sensor for determining a direction of movement of the member and pressure of movement wherein the direction of movement determines a forward or backward sequence and the pressure determines the speed of the sequence. Furthermore, the feedback mechanism of the cursor control device applies a force on the movable member in a direction opposite the direction of movement of the user when a marker has been detected by the processor.

In another aspect of the present invention, system includes a scanner for scanning and collecting the plurality of images.

In a further aspect of the present invention, system includes an image detector for detecting objects of interest in an image and marking the image and/or marking the detected objects.

According to another aspect of the present invention, a method for reviewing a plurality of images at high speed is provided. The method includes the steps of marking at least one of the plurality of images having an object of interest; displaying at least one image of the plurality of images; applying a first force to a cursor control device to sequentially display the plurality of images; detecting an image having an object of interest; applying a feedback force to the cursor control; and removing the first force from the cursor control and stopping the sequence at the marker image.

The method further includes the steps of acquiring the plurality of images by a scanner device; and compiling the plurality of images in a sequential manner.

In yet another aspect, the marking step includes initially reviewing each of the plurality of images and manually marking objects of interest. Alternatively, the marking step includes processing each of the plurality of images with an automatic image detection algorithm for detecting objects of interest and marking the objects In another aspect, the cursor control device is a joystick. The cursor control device includes a movable member manipulated by the user in at least one degree of freedom for applying the first force; a sensor for determining a direction of movement of the member and pressure of movement wherein the direction of movement determines a forward or backward sequence and the pressure determines the speed of the sequence; and a feedback mechanism for applying a feedback force on the movable member in a direction opposite the direction of movement of the user when a marker has been detected.

According to a further aspect of the present invention, a program storage device readable by a machine, tangibly embodying a program of instructions executable by the machine to perform the method steps for reviewing a plurality of images at high speed is provided, the method steps including marking at least one of the plurality of images having an object of interest; displaying at least one image of the plurality of images; applying a first force to a cursor control device to sequentially display the plurality of images; detecting an image having an object of interest; applying a feedback force to the cursor control; and removing the first force from the cursor control and stopping the sequence at the marker image.

### BRIEF DESCRIPTION OF THE DRAWINGS

The above and other aspects, features, and advantages of the present invention will become more apparent in light of the following detailed description when taken in conjunction with the accompanying drawings in which:

FIG. 1 is a block diagram of an exemplary system for reviewing a large volume of images at high speed in accordance with the present invention;

FIG. 2A is a prospective view of a joystick to be employed by the system of FIG. 1 in accordance with an embodiment of the present invention;

FIG. 2B is a schematic diagram of the joystick shown in FIG. 2A; and

FIG. 3 is a flowchart illustrating a method for reviewing a large volume of images in accordance with an embodiment of the present invention.

### DETAILED DESCRIPTION OF PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail.

A system and method for reviewing a large volume of images at high speed is provided. A cursor control device, e.g., a joystick, with force feedback is employed to scroll through a series of images on a display where feedback is provided to a user when a marked image is encountered. The joystick can control the direction in which to scroll the images as well as the speed of scrolling. The markers can be felt as small zones of attraction. If the user wants to look at any marked image, the user would scroll through the set of images at moderate speed, until they feel feedback to stop, e.g., a small bump. The user then can either let the joystick loose, in which case they would be attracted to the image containing the maker, or they can overcome the attraction by using more force, to continue scrolling.

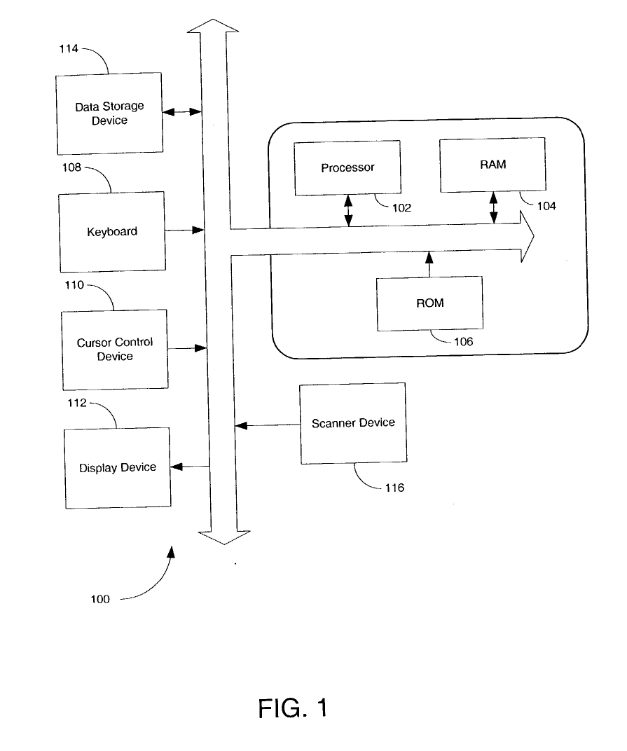

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture such as that shown in FIG. 1. Preferably, the machine 100 is implemented on a computer platform having hardware such as one or more central processing units (CPU) 102, a random access memory (RAM) 104, a read only memory (ROM) 106 and input/output (I/O) interface(s) such as keyboard 108, cursor control device (e.g., a mouse or joystick) 110 and display device 112. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device 114 and a printing device. Furthermore, a scanner device 116, for example an X-ray machine or MRI (magnetic resonance imaging) machine, may be coupled to the machine 100 for collecting two-dimensional (2D) image data.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

With continued reference to FIG. 1, a system 100 for reviewing a large volume of images includes a display 112 for displaying the large volume of images sequentially, a cursor control device 110 for controlling a speed of the sequentially displayed images, the cursor control device 110 include a feedback mechanism and a processor 102 for receiving a direction control signal from the cursor control device 110 and presenting the sequence of images to the display 112 in the determined direction, and for determining if any image in the sequence has a marker, wherein if a marker is detected, the processor 102 outputs a feedback signal to the cursor control device 110 to indicate to a user to review the image. The system 100 further includes a storage device 114 for storing the plurality of images.

It is to be appreciated that the series of images may be collected and complied by a machine external to system 100. The series of image may then be stored in the system in RAM 104 or the storage device 114, e.g., a hard disk, or may be stored on a removable storage device to be loaded onto the system 100 at a later time. Alternatively, a scanner device 116 may be coupled to the system 100 for generating two-dimensional (2D) images and storing the 2D images in one the system's 100 memories. The scanner device 100 may be a CT machine, MRI machine or any device known in the art for generating 2D slice images of a human body.

Once the series of images has been collected and sequentially complied, images including objects of interest are marked. The objects of interest may be any mass, nodule or shape which appears in any image that requires more than a cursory review by a doctor or radiologist, e.g., a nodule in lung images or polyps in colon images. Images may be marked manually by reviewing each image and marking the object of interest and/or marking the images as containing an object of interest. Alternatively, the images may be marked by processing each image with computer-assisted diagnosis (CAD) software. The CAD software will identify objects of interest automatically and tag the image as containing such. Examples of such CAD software are disclosed in U.S. Pat. No. 6,240,201 entitled “COMPUTERIZED DETECTION OF LUNG NODULES USING ENERGY-SUBTRACTED SOFT-TISSUE AND STANDARD CHEST IMAGES” issued to Xu et al. on May 29, 2001; U.S. Pat. No. 6,301,378 entitled “METHOD AND APPARATUS FOR AUTOMATED DETECTION OF MASSES IN DIGITAL MAMMOGRAMS” issued to Karssemeijer et al. on Oct. 9, 2001; U.S. patent application Ser. No. 09/840,266 entitled “AUTOMATIC DETECTION OF LUNG NODULES FROM HIGH RESOLUTION CT IMAGED” filed by Fan et al. on Apr. 23, 2001; and U.S. patent application Ser. No. 10/137,839 entitled “METHOD FOR DETECTING SHAPES IN MEDICAL IMAGES” filed by Paik et al. on May 3, 2002, the contents of the above U.S. patents and applications are incorporated herein by reference.

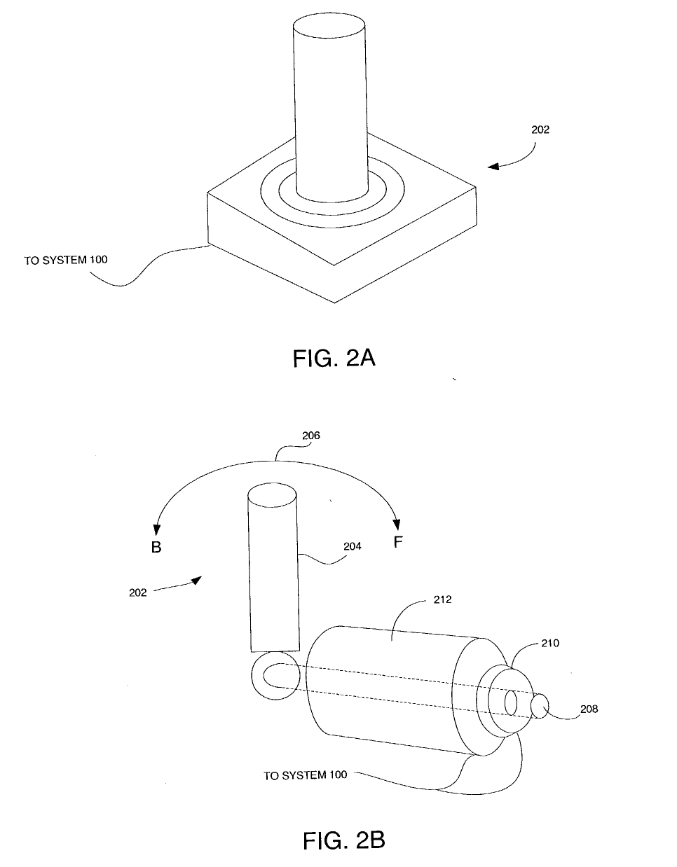

In a preferred embodiment, the cursor control device is a joystick 202 as shown in FIG. 2A. FIG. 2B is a schematic diagram of the joystick shown in FIG. 2A. The joystick 202 includes a movable member 204 to be manipulated by a user to cause the series of images to be scrolled on the display 112. The movable member 204 can move in at least one degree of freedom 206, where applying pressure to the member 204 in the F direction causes scrolling of the images to occur in a forward direction and applying pressure in the B direction causes scrolling to occur in the backwards direction. The member 204 is coupled to a shaft 208 which supports a sensor 210 for sensing the direction of an applied force on the member 204 and outputting a direction control signal to the processor 102. Examples of such sensors include rotary or linear potentiometers, optical encoders and linear displacement voltage transducers. Also, the sensor can detect the amount of pressure applied in either direction to determine a speed to scroll the images, and subsequently, send a speed control signal to the processor 102.

Furthermore, the joystick 202 includes a feedback mechanism 212 coupled to shaft 208 for applying a force to the movable member 204. Examples of such feedback mechanisms include an actuator and servo motor. The feedback mechanism 212 applies a force on the movable member 206 in a direction opposite the direction of movement of the user when a marker has been detected by the processor 102.

In a further embodiment, the joystick may include a movable member that moves in multiple degrees of freedom. In such an embodiment, the joystick will employ various gimbal mechanisms to enable the joystick to pivot about multiple axes. An example of such a joystick is disclosed in U.S. Pat. No. 6,429,849 entitled “HAPTIC FEEDBACK JOYSTICK” issued to An et al. on Aug. 6, 2002, the contents of which is incorporated by reference. In this embodiment, once a user has found an image including an object of interest, the user can manipulate the member to zoom in on a particular feature of the image.

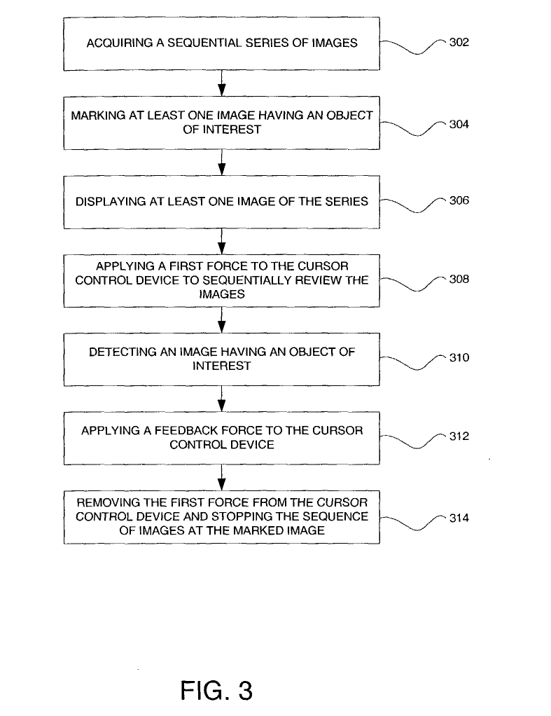

Referring to FIG. 3, a flowchart illustrating a method of reviewing a large volume of images is provided. Initially, a sequential series of images are acquired (step 302). The images may be acquired through a CT screening process where hundreds of image slices are taken of a chest area of an individual. The images are sequentially complied so during a review process a user will review images from one end of the chest to the other.

Next, images containing an object of interest are marked either manually or by automatic detection methods described above (step 304). It is to be understood that when marking the images either the object of interest is marked, e.g., highlighted, and/or the image itself is marked. When an image is marked, it is to be appreciated that the mark may not be a visual marker to be viewed by the user but a tag in software to identify to the processor that the image has an object of interest. Once the images have been marked, at least one of the images will be displayed on the display device 112 (step 306), preferably the first image in the sequence.

When the reviewing process begins, the user will apply a force to the member 204 of the joystick 202 to begin the sequence (step 308). Referring to FIG. 2B, if the user applies a force in direction F, the series of images will begin to scroll forward. The scrolling speed will be determined by how much force is applied by the user. As the images are scrolling, the processor is checking each image to determine if an image is marked and/or tagged or if it includes an object of interest (step 310).

If a marker is detected, the processor 102 outputs a control signal to the feedback mechanism 212 to apply a force in a direction opposite to the direction of the force applied by the user (step 312). For example, if the user is applying a forward F force and a marker is detected, the member 204 of the joystick 202 will be forced in the backward B direction in the user's hand by the feedback mechanism 212.

Upon feeling the feedback, the user will remove the force being applied and the sequence of images will stop at the marked image (step 314). Alternatively, the user may wish to continue passed the marked image and will therefore apply a greater force in the forward F direction overcoming the feedback force. Once the user has stopped at the marked image, the user may freely move back and forth in the sequence to review surrounding areas.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A system for reviewing a plurality of images, at least one image including a marker, the system comprising:
a display for displaying the plurality of images sequentially;
a cursor control device for controlling a speed of the sequentially displayed images, the cursor control device including a feedback mechanism; and
a processor for receiving a direction control signal from the cursor control device and presenting the sequence of images to the display in the determined direction, and for determining if any image in the sequence has a marker, wherein if a marker is detected, the processor outputs a feedback signal to the feedback mechanism of the cursor control device to indicate to a user to review the image.

2. The system as in claim 1, further comprising a storage device for storing the plurality of images.

3. The system as in claim 1, wherein the cursor control device is a joystick.

4. The system as in claim 1, wherein the cursor control device comprises
a movable member manipulated by the user in at least one degree of freedom; and
a sensor for determining a direction of movement of the member and pressure of movement wherein the direction of movement determines a forward or backward sequence and the pressure determines the speed of the sequence.

5. The system as in claim 4, wherein the feedback mechanism applies a force on the movable member in a direction opposite the direction of movement of the user when a marker has been detected by the processor.

6. The system as in claim 1, further comprising a scanner for scanning and collecting the plurality of images.

7. The system as in claim 1, further comprising an image detector for detecting objects of interest in an image and marking the image.

8. The system as in claim 1, further comprising an image detector for detecting objects of interest in an image and marking the detected objects.

9. The system as in claim 4, wherein the member is movable in a plurality of degrees of freedom and, upon detecting an image including a marker, the member can be utilized to zoom in on the object of interest.

10. A method for reviewing a plurality of images at high speed, the method comprising the steps of:
marking at least one of the plurality of images having an object of interest;
displaying at least one image of the plurality of images;
applying a first force to a cursor control device to sequentially display the plurality of images;
detecting an image having an object of interest;
applying a feedback force to the cursor control; and
removing the first force from the cursor control and stopping the sequence at the marker image.

11. The method as in claim 10, further comprising the steps of:
acquiring the plurality of images by a scanner device; and
compiling the plurality of images in a sequential manner.

12. The method as in claim 10, wherein the marking step includes initially reviewing each of the plurality of images and manually marking objects of interest.

13. The method as in claim 10, wherein the marking step further includes processing each of the plurality of images with an automatic image detection algorithm for detecting objects of interest and marking the objects.

14. The method as in claim 10, wherein the feedback force is applied in a direction opposite the first force.

15. The method as in claim 10, wherein the cursor control device is a joystick.

16. The method as in claim 10, wherein the cursor control device comprises
a movable member manipulated by the user in at least one degree of freedom for applying the first force;
a sensor for determining a direction of movement of the member and pressure of movement wherein the direction of movement determines a forward or backward sequence and the pressure determines the speed of the sequence; and
a feedback mechanism for applying a feedback force on the movable member in a direction opposite the direction of movement of the user when a marker has been detected.

17. The method as in claim 10, wherein, if the first force is greater than the feedback force, continue to sequentially display the plurality of images.

18. A program storage device readable by a machine, tangibly embodying a program of instructions executable by the machine to perform the method steps for reviewing a plurality of images at high speed, the method steps comprising:
marking at least one of the plurality of images having an object of interest;
displaying at least one image of the plurality of images;
applying a first force to a cursor control device to sequentially display the plurality of images;
detecting an image having an object of interest;
applying a feedback force to the cursor control; and
removing the first force from the cursor control and stopping the sequence at the marker image.
